(19) United States
(12) Patent Application Publication
(10) Pub. No.: US 2006/0223379 A1
(43) Pub. Date: Oct. 5, 2006

(54) Latched electrical connector assembly

(75) Inventor: Yi-Tse Ho, Tainan Hsien (TW)

Correspondence Address: MOLEX INCORPORATED, 2222 WELLINGTON COURT, LISLE, IL, 60532, US

(73) Assignee: MOLEX INCORPORATED

(21) Appl. No.: 11/389,975

(22) Filed: Mar. 27, 2006

(30) Foreign Application Priority Data
Apr. 1, 2005 (TW) 94205094

(51) Int. Cl. H01R 24/00

(52) U.S. Cl. 439/660

(57) ABSTRACT

An electrical connector assembly includes a first connector for mounting on a circuit board and a second connector for mating with the first connector. The first connector includes an insulative upright body having a front mating face and a rear terminating face. A plurality of terminal-receiving passages extend through the body between the front and rear faces thereof. An engaging plate extends from the mating face in a forward mating direction away from the body. The engaging plate has a first retaining protrusion projecting transversely of the mating direction and defining a retaining groove therebehind between the protrusion and the front mating face of the body. A plurality of terminals extend through the passages and include contact portions projecting forwardly from the mating face of the body generally parallel to the engaging plate. The second connector includes an insulative housing having a plurality of holes for receiving the contact portions of the terminals projecting from the body of the first connector into engagement with conductive contacts of the second connector. The housing has a second retaining protrusion for latching engagement within the groove behind the first retaining protrusion on the engaging plate of the first connector.

### FIELD OF THE INVENTION

This invention generally relates to the art of electrical connectors and, particularly, to an electrical connector assembly which includes a pair of mating connectors which have improved latch means to hold the connectors in mated condition.

### BACKGROUND OF THE INVENTION

A typical electrical connector assembly includes a male or plug connector which is mateable with a female or receptacle connector. The two connectors often have some form of interengageable latch means, such as flexible latch arms, for holding the connectors in mated condition.

For instance, FIG. 1 shows an electrical connector assembly, generally designated 6, which includes a plug connector, generally designated 8, for mating with a receptacle connector, generally designated 10. Plug connector 8 includes a molded plastic housing, generally designated 12, which has an upright body portion 12a. The housing is molded of plastic material and includes a plurality of through passages 12b which extend through body portion 12a. A plurality of conductive pin terminals, generally designated 14, are inserted through passages 12b. The pin terminals have contact portions 14a which project forwardly of body portion 12a for insertion into a plurality of sockets 16 in a housing 17 of receptacle connector 10 for engaging appropriate contacts or terminals (not shown) within the sockets. Terminals 14 are right-angled or L-shaped and include tail portions 14b bent downwardly behind body portion 12a for insertion into appropriate holes in a printed circuit board and for connection, as by soldering, to appropriate circuit traces on the board and/or in the holes.

Like housing 12 of plug connector 8, housing 17 of receptacle connector 10 is a molded plastic structure. Housing 12 of connector 8 includes a pair of latch arms 18 which project forwardly for interengagement with a complementary pair of flexible latch arms 19 at opposite sides or ends of receptacle connector 10. Latch arms 18 are molded integrally with housing 12 of plug connector 8, and latch arms 19 are molded integrally with housing 14 of receptacle connector 10. At least latch arms 19 are flexible for interengagement with latch arms 18. In any event, both latch arms 18 and both latch arms 19 are fabricated of breakable plastic material and are exposed at opposite ends of the respective connectors. Therefore, the latch arms are easy to break and, thereby, one or both of the connectors which would be destroyed and would have to be discarded. The present invention is designed to solve these problems.

### SUMMARY OF THE INVENTION

An object, therefore, of the invention is to provide an electrical connector assembly with an improved latch means for retaining a pair of connectors in mated condition.

In the exemplary embodiment of the invention, an electrical connector assembly includes a first connector for mounting on a circuit board and a second connector for mating with the first connector. The first connector includes an insulative upright body having a front mating face and a rear terminating face. A plurality of terminal-receiving passages extend through the body between the front and rear faces thereof. An engaging plate extends from the mating face in a forward mating direction away from the body. The engaging plate has a first retaining protrusion projecting transversely of the mating direction and defining a retaining groove therebehind between the protrusion and the front mating face of the body. A plurality of terminals extend through the passages and include contact portions projecting forwardly from the mating face of the body generally parallel to the engaging plate. The second connector includes an insulative housing having a plurality of holes for receiving the contact portions of the terminals projecting from the body of the first connector into engagement with conductive contacts of the second connector. The housing has a second retaining protrusion for latching engagement within the groove behind the first retaining protrusion on the engaging plate of the first connector.

According to one aspect of the invention, the first retaining protrusion and the groove are formed on a top side of the engaging plate of the first connector. The second retaining protrusion is formed on a bottom side of the housing of the second connector.

According to another aspect of the invention, the housing of the second connector includes a channel for guiding the engaging plate of the first connector thereinto. The channel is formed between a pair of guide walls depending from the bottom side of the housing of the second connector.

According to a further aspect of the invention, a front edge of the first retaining protrusion is chamfered to facilitate the second retaining protrusion to ride over the first retaining protrusion into the retaining groove during mating of the connectors. In the preferred embodiment, a rear edge of the first retaining protrusion is chamfered to facilitate the second retaining protrusion to ride over the first retaining protrusion out of the retaining groove during unmating of the connectors.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the FIGS. and in which:

FIG. 1 is a perspective view of an electrical connector assembly according to the prior art and as described in the Background, above;

FIG. 2 is a top perspective view of an electrical connector assembly according to the invention, with the connectors unmated, with one of the terminals removed from the plug connector, and in conjunction with a printed circuit board onto which the plug connector is mounted;

FIG. 3 is a bottom perspective view of the connector assembly of FIG. 1;

FIG. 4 is a top plan view of the plug connector; and

FIG. 5 is a side elevational view of the connectors in mated condition, with the plug connector mounted on the printed circuit board.

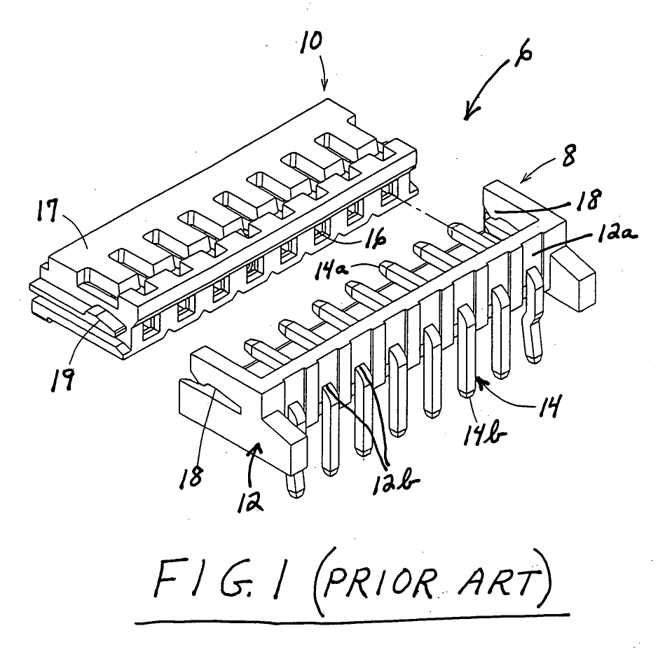

### DETAILED DESCRIPTION OF THE PREFERRED EMBODIMENT

Before proceeding with a detailed description of the invention, it should be understood that such terms as “top”, “bottom”, “upright”, “forward”, “rearward”, “front”, “rear” and the like herein and in the claims hereof are not meant in any way to be limiting in nature. These terms are used only to provide a clear and concise understanding of the invention as depicted in the drawings. The electrical connector assembly herein is omni-directional in use and function.

With those understandings and referring to the drawings in greater detail, the invention is embodied in an electrical connector assembly, generally designated 20, which includes a first or plug connector, generally designated 22, which is mateable with a second or receptacle connector, generally designated 24. The plug connector is mountable on a printed circuit board, generally designated 26, which has a plurality of holes 26a. Appropriate circuit traces (not shown) are provided on the circuit board and/or in the holes.

Plug connector 22 includes an insulative upright body 28 which has a front mating face 28a and a rear terminating face 28b. A plurality of terminal-receiving passages 30 extend through the body between the front and rear faces thereof. The body is relatively thin in a front-to-rear direction. A plurality of partition bosses 32 project rearwardly of the terminating face of the body, between passages 30, to define a plurality of grooves 34 therebetween. The grooves are aligned with the passages and within which terminating portions of the connector terminals are disposed as seen hereinafter.

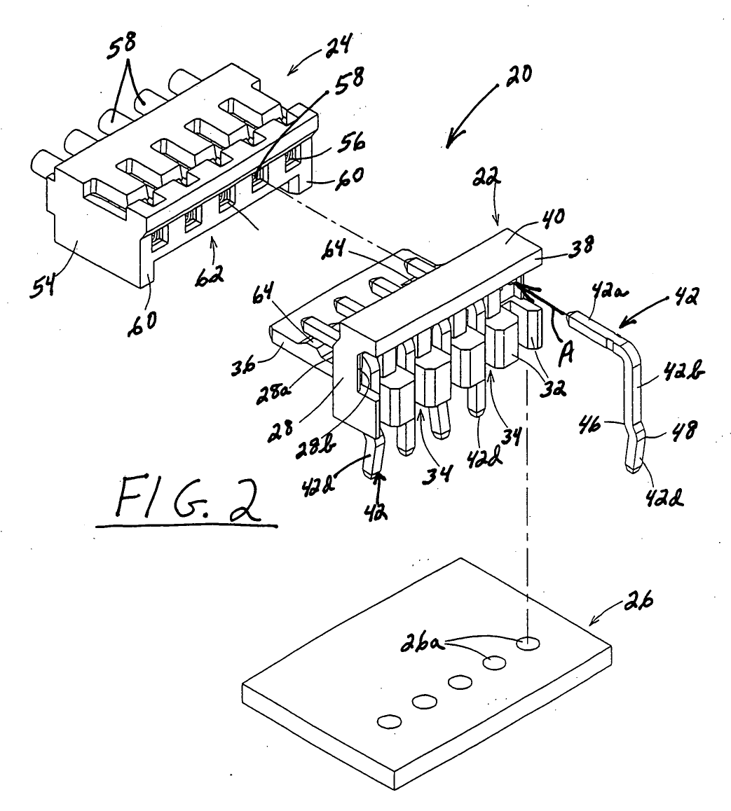

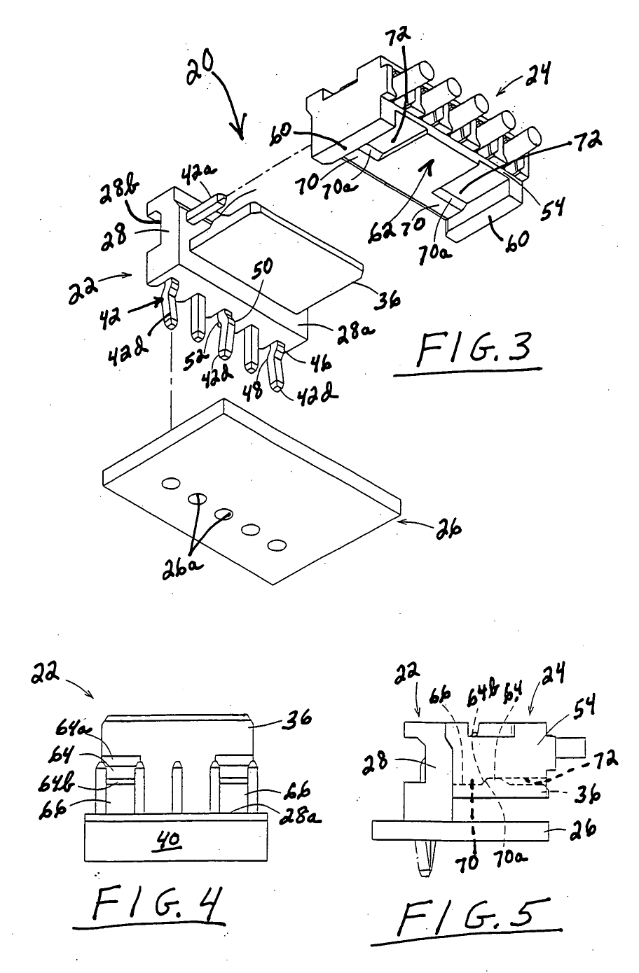

An engaging plate 36 extends from mating face 28a of body 28 in a forward mating direction away from the body. An extension plate 38 extends from the rear terminating face 28b of the body in a rearward direction away from an upper distal end of the body. The engaging plate and the extension plate are generally flat and are generally parallel to each other as well as parallel to the printed circuit board 26 when plug connector 22 is mounted on the board. An upper surface of the distal end of body 28 and an upper surface of extension plate 38 are coplanar to define a relatively large vacuum suction surface 40 as seen in FIGS. 2 and 4. The suction surface is significantly larger than the front-to-rear thickness of body 28 as can be seen in FIG. 3. Therefore, the body can be molded quite thin to easily mold the terminal-receiving passages 30 therethrough, while still providing a relatively large vacuum suction surface 40 at the top of the body. Terminating portions 42b of the terminals are completely protected at the top by extension plate 38, and along their sides by partition bosses 32. Body 28 of plug connector 22, including engaging plate 36, extension plate 38 and partition bosses 32, preferably is a one-piece structure unitarily molded of dielectric material such as plastic or the like.

A plurality of conductive pin-type terminals, generally designated 42, are mounted in body 28 of plug connector 22. As seen best by the one removed terminal 42 in FIG. 2, each terminal is bent in an L-shaped configuration to define a forwardly projecting, pin-like contact portion 42a and a downwardly extending terminating portion 42b. The terminals are mounted into plug connector 22 by inserting contact portions 42a into and through passages 30 in body 28, in the direction of arrow “A” shown in FIG. 2. The terminating portions of the terminals have tail portions 42d for insertion into holes 26a of circuit board 26 and for connection, as by soldering, to appropriate circuit traces on the board and/or in the holes. The tail portions 42d are formed relative to the respective terminating portions 42b of at least some of the terminals 42, so that plug connector 22 is maintained in a stable, substantially immovable condition on circuit board 26 during a soldering process of connecting the tail portions to the circuit traces on the printed circuit board.

Specifically, referring to FIGS. 2 and 3, tail portions 42d of the two end-most terminals 42 are offset rearwardly of the respective terminating portions of those end-most terminals. This creates front angled surfaces 46 and rear angled surfaces 48 which engage the edges of the respective holes 26a in the circuit board. As seen in FIG. 3, tail portion 42d of the center-most terminal is offset forwardly relative to the terminating portion of the respective terminal to define a front angled surface 50 and a rear angled surface 52 which, again, engage the edges of the center-most hole 26a in the circuit board. These oppositely offset tail portions (i.e., the center-most tail portion being offset in a direction opposite the end-most tail portions) create opposing forces when all of the tail portions are inserted into holes 26a and, thereby, maintain plug connector 22 in a stable upright condition while the tail portions are soldered to the circuit board.

The second or receptacle connector 24 includes an insulative housing 54 having a plurality of sockets 56 for receiving the pin-like contact portions 42a of terminals 42 of plug connector 22. A plurality of conductive female contacts or terminals 58 are disposed within the sockets for receiving and electrically connecting to the contact portions 42a. Contacts 58 can be connected to appropriate electrical wires or other conductors (not shown). Housing 54 of receptacle connector 24 is a one piece structure unitarily molded of dielectric material such as plastic or the like. The housing includes a pair of side guide walls 60 depending from the bottom thereof to define a channel, generally designated 62, (FIG. 2) for receiving and guiding engaging plate 36 of plug connector 22 between the side guide walls 60 at the bottom of the receptacle connector.

Generally, interengaging latch means are provided to hold plug connector 22 and receptacle connector 24 in mated condition. Specifically, as best seen in FIG. 4, a pair of transversely spaced, first retaining protrusions 64 project upwardly from the top of engaging plate 36 of plug connector 22. In other words, protrusions 64 project transversely (i.e., upwardly) of the mating direction of the connectors. The protrusions define retaining grooves 66 therebehind, i.e., between the protrusions and body 28. The protrusions have front chamfered edges 64a and rear chamfered edges 64b. As seen in FIG. 3, the bottom of housing 54 of receptacle connector 24 includes a pair of laterally spaced, second retaining protrusions 70 which define retaining grooves 72 therebehind. Retaining protrusions 70 have chamfered edges 70a.

When the plug and receptacle connectors 22 and 24, respectively, are mated, two things occur. First, the pin-like contact portions 42a of terminals 42 of the plug connector are inserted into sockets 56 of receptacle connector 24 and into engagement with contacts 58 of the receptacle connector. Second, the first retaining protrusions 64 on the plug connector and the second retaining protrusions 70 on the receptacle connector ride over each other due to the chamfered edges of the protrusions, until protrusions 64 on the plug connector snap into retaining grooves 72 on the receptacle connector, while protrusions 70 on the receptacle connector simultaneously snap into retaining grooves 66 on the plug connector. This can be seen in FIG. 5. Since the interengagement of the terminals or contacts between the two connectors prevent the connectors from moving transversely of the mating direction, the respective retaining protrusions on the two connectors cannot inadvertently pull out of the retaining grooves of the other connector. On the other hand, because of the chamfered edges of the retaining protrusions of the respective connectors, the connectors can be unmated by riding the protrusions back over each other while separating the connectors.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector assembly, comprising:
a first connector for mounting on a circuit board and including
an insulative upright body having a front mating face and a rear terminating face with a plurality of terminal-receiving passages extending through the body between the front and rear faces thereof and an engaging plate extending from the mating face in a forward mating direction away from the body, the engaging plate having a first retaining protrusion projecting transversely of the mating direction and defining a retaining groove therebehind between the protrusion and the front mating face of the body, and
a plurality of terminals extending through the terminal-receiving passages in the body, the terminals having contact portions projecting forwardly from the mating face of the body generally parallel to the engaging plate, and the terminals having terminating portions projecting from the rear face of the body for connection to appropriate circuit traces on the circuit board; and
a second connector including an insulative housing having a plurality of holes for receiving the contact portions of the terminals projecting from the body of the first connector into engagement with conductive contacts of the second connector, the housing having a second retaining protrusion for latching engagement within the groove behind the first retaining protrusion on the engaging plate of the first connector.

2. The electrical connector assembly of claim 1 wherein said first retaining protrusion and said groove are formed on a top side of the engaging plate of the first connector.

3. The electrical connector assembly of claim 2 wherein said second retaining protrusion is formed on a bottom side of the housing of the second connector.

4. The electrical connector assembly of claim 1 wherein the housing of said second connector includes a guide channel for guiding the engaging plate of the first connector thereinto.

5. The electrical connector assembly of claim 4 wherein said channel is formed between a pair of guide walls depending from a bottom side of the housing of the second connector.

6. The electrical connector assembly of claim 1 wherein a front edge of the first retaining protrusion is chamfered to facilitate the second retaining protrusion to ride over the first retaining protrusion into said retaining groove during mating of the connectors.

7. The electrical connector assembly of claim 1 wherein a rear edge of the first retaining protrusion is chamfered to facilitate the second retaining protrusion to ride over the first retaining protrusion out of said retaining groove during unmating of the connectors.

8. The electrical connector assembly of claim 7 wherein a front edge of the first retaining protrusion is chamfered to facilitate the second retaining protrusion to ride over the first retaining protrusion into said retaining groove during mating of the connectors.

9. The electrical connector assembly of claim 1 wherein said terminals are generally L-shaped, with the terminating portions being bent downwardly behind the body.

10. The electrical connector assembly of claim 9 wherein the terminating portions of said terminals have tail portions for insertion into appropriate holes in the circuit board.

11. The electrical connector assembly of claim 1 wherein the terminating portions of at least some of said terminals have tail portions for insertion into appropriate holes in the circuit board, the tail portions being offset to define angled shoulders for engaging edges of the holes.

12. The electrical connector assembly of claim 11 wherein the tail portions of said at least some of the terminals are offset in said forward mating direction, and tail portions of other of the terminals are offset in said rearward direction.

13. An electrical connector assembly, comprising:
a first connector for mounting on a circuit board and including
an insulative upright body having a front mating face and a rear terminating face with a plurality of terminal-receiving passages extending through the body between the front and rear faces thereof and an engaging plate extending from the mating face in a forward mating direction away from the body, the engaging plate having a first retaining protrusion projecting from a top side of the engaging plate transversely of the mating direction and defining a retaining groove therebehind between the protrusion and the front mating face of the body, and
a plurality of terminals extending through the terminal-receiving passages in the body, the terminals having contact portions projecting forwardly from the mating face of the body generally parallel to the engaging plate, and the terminals having terminating portions projecting from the rear face of the body for connection to appropriate circuit traces on the circuit board; and
a second connector including an insulative housing having a plurality of holes for receiving the contact portions of the terminals projecting from the body of the first connector into engagement with conductive contacts of the second connector, the housing having a second retaining protrusion formed on a bottom side of the housing for latching engagement within the groove behind the first retaining protrusion on the engaging plate of the first connector, and the housing having a guide channel formed between a pair of guide walls depending from the bottom side of the housing for guiding the engaging plate of the first connector thereinto.

14. The electrical connector assembly of claim 13, including a pair of said first retaining protrusions on the first connector spaced transversely of said mating direction and engageable by a pair of second protrusions on the second connector.

15. The electrical connector assembly of claim 13 wherein a front edge of the first retaining protrusion is chamfered to facilitate the second retaining protrusion to ride over the first retaining protrusion into said retaining groove during mating of the connectors.

16. The electrical connector assembly of claim 13 wherein a rear edge of the first retaining protrusion is chamfered to facilitate the second retaining protrusion to ride over the first retaining protrusion out of said retaining groove during unmating of the connectors.

17. The electrical connector assembly of claim 16 wherein a front edge of the first retaining protrusion is chamfered to facilitate the second retaining protrusion to ride over the first retaining protrusion into said retaining groove during mating of the connectors.

18. An electrical connector assembly, comprising:
a first connector including
an insulative upright body having a front mating face and a rear terminating face with a plurality of terminal-receiving passages extending through the body between the front and rear faces thereof and an engaging plate extending from the mating face in a forward mating direction away from the body, the engaging plate having a first retaining protrusion projecting transversely of the mating direction and defining a retaining groove therebehind between the protrusion and the front mating face of the body, and
a plurality of terminals extending through the terminal-receiving passages in the body, the terminals having contact portions projecting forwardly from the mating face of the body generally parallel to the engaging plate; and
a second connector including an insulative housing having a plurality of holes for receiving the contact portions of the terminals projecting from the body of the first connector into engagement with conductive contacts of the second connector, the housing having a second retaining protrusion for latching engagement within the groove behind the first retaining protrusion on the engaging plate of the first connector.

19. The electrical connector assembly of claim 18 wherein said first retaining protrusion and said groove are formed on a top side of the engaging plate of the first connector.

20. The electrical connector assembly of claim 19 wherein said second retaining protrusion is formed on a bottom side of the housing of the second connector.

21. The electrical connector assembly of claim 18 wherein the housing of said second connector includes a guide channel for guiding the engaging plate of the first connector thereinto.

22. The electrical connector assembly of claim 21 wherein said channel is formed between a pair of guide walls depending from a bottom side of the housing of the second connector.

23. The electrical connector assembly of claim 18, including a pair of said first retaining protrusions on the first connector spaced transversely of said mating direction and engageable by a pair of second protrusions on the second connector.
